(19) United States
(12) Patent Application Publication
(10) Pub. No.: US 2003/0074470 A1
(43) Pub. Date: Apr. 17, 2003

(54) Server communications system, and internet protocol packet transferring method

(76) Inventor: Shuji Karino, Chiryu-City (JP)

Correspondence Address: HARNESS, DICKEY & PIERCE, P.L.C., P.O. BOX 828, BLOOMFIELD HILLS, MI, 48303, US

(21) Appl. No.: 10/269,218

(22) Filed: Oct. 11, 2002

(30) Foreign Application Priority Data
Oct. 15, 2001 (JP) 2001-316752

(51) Int. Cl. G06F 15/173; G06F 15/16

(52) U.S. Cl. 709/239; 709/219

(57) ABSTRACT

A home server receives an IP packet addressed to a cellular phone from a host. When a cellular phone uses a roaming server as a current default server, the home server transmits transfer destination information, which indicates the roaming server as the current default server of the cellular phone, to the host. Then, the host recognizes that the cellular phone uses the roaming server as the current default server. Thus, the host transmits any further IP packet addressed to the cellular phone directly to the roaming server.

### CROSS REFERENCE TO RELATED APPLICATION

This application is based on and incorporates herein by reference Japanese Patent Application No. 2001-316752 filed on Oct. 15, 2001.

### BACKGROUND OF THE INVENTION

1. Field of the Invention

The present invention relates to a server storing a correspondence table that indicates a relationship between each communications terminal identification number, which identifies a corresponding communications terminal, and a corresponding current default server, which is currently used by the communications terminal. The present invention further relates to a communications system that includes such a server and a host. The present invention also relates to an IP packet transferring method.

2. Description of Related Art

One previously proposed server manages a position of each mobile communications terminal, such as a cellular phone, in a manner described in the following example. With reference to FIG. 4, in this example, a cellular phone 1 is used as an exemplary communications terminal. Furthermore, it is assumed that a first server (A) 2 serves as a home server, in which various information (e.g., a telephone number, an internet protocol address, etc.) of the cellular phone 1 is stored.

When the cellular phone 1 is located within a communication range of the first server 2, and the first server 2 is notified from the cellular phone 1 that the first server 2 is the home server of the cellular phone 1 at S1 in FIG. 4, the first server 2 notifies the cellular phone 1 that the home server of the cellular phone 1 and a current default server (i.e., a server which is currently used by and is communicatable with the cellular phone 1) of the cellular phone 1 coincides with each other at S2 in FIG. 4.

When the cellular phone 1 moves from the communication range of the first server 2 to a communication range of a second server (B) 3, the second server 3, which now serves as a roaming server that provide a roaming service to the cellular phone 1, is notified from the cellular phone 1 that the cellular phone 1 is located within the communication range of the second server 3, and the first server 2 is the home server of the cellular phone 1 at S3 in FIG. 4. In this case, as described above, the second server 3 is not the home server of the cellular phone 1 and is the roaming server of the cellular phone 1. Thus, the second server 3 notifies the cellular phone 1 that the current default server of the cellular phone 1 is different from the home server of the cellular phone 1 at S4 in FIG. 4. At this time, the second server 3 transmits transfer destination (TD) information to the first server 2, which is the home server of the cellular phone 1, at S5 in FIG. 4. The transfer destination information indicates that the cellular phone 1, which does not use the second server 3 as the home server of the cellular phone 1, is located within the communication range of the second server 3.

The first server 2 stores a correspondence table in a database 4. The correspondence table indicates a relationship between an internet protocol (IP) address of the cellular phone 1 and the current default server of the cellular phone. When the first server 2 receives the transfer destination information from the second server 3, the first server 2 interprets the transfer destination information and recognizes that the cellular phone 1 uses the second server 3, which is the roaming server of the cellular phone 1, as the current default server. Then, the first server 2 updates the correspondence table based on this information at S6 in FIG. 4. In this way, the first server 2 can recognize that the cellular phone 1 now uses the second server 3 as the current default server.

With reference to FIG. 5, in the IP communications where the internet protocol is used as the communication protocol, when the cellular phone 1 uses the first server 2 as the current default server, the first server 2 can directly receives an IP packet (IP datagram), which is addressed to the cellular phone 1, from a host 5. Also, when the first server 2 receives an IP packet, which is addressed to the host 5, from the cellular phone 1, the first server 2 can directly transmit the received IP packet to the host 5 at S7 and S8 in FIG. 5.

However, as shown in FIG. 6, when the cellular phone 1 uses the second server 3, which is the roaming server of the cellular phone 1, as the current default server, the second server 3 needs to receive an IP packet, which is addressed to the cellular phone 1, from the host 5 through the first server 2. Also, when the second server 3 receives an IP packet, which is addressed to the host 5, from the cellular phone 1, the second server 3 needs to transmit the IP packet to the host 5 through the first server 2 at S9, S10 and S11 in FIG. 6. That is, the transmission of the IP packets between the host 5 and the cellular phone 1 has to be performed through both the first server 2 and the second server 3. This causes heavy traffic in a corresponding network, causing an increase in a load of the network.

### SUMMARY OF THE INVENTION

The present invention addresses the above disadvantages. Thus, it is an objective of the present invention to reduce a load of a corresponding network when IP packets are communicated through the network.

To achieve the objective of the present invention, there is provided a server including a means for receiving an internet protocol packet, a means for storing a correspondence table, a means for searching the correspondence table, and a means for transmitting transfer destination information of a communications terminal. The means for receiving the internet protocol packet receives an internet protocol packet, which is transmitted from a host and is addressed to the communications terminal that uses the server as a home server of the communications terminal. The correspondence table indicates a relationship between a communications terminal identification number of the communications terminal and a current default server of the communications terminal. The means for searching the correspondence table searches the correspondence table to obtain transfer destination information of the communications terminal, which indicates the current default server of the communications terminal, when the communications terminal uses a roaming server as the current default server of the communications terminal such that the transfer destination information of the communications terminal indicates the roaming server as the current default server of the communications terminal. The means for transmitting the transfer destination information transmits the transfer destination information of the communications terminal, which indicates the roaming server as the current default server of the communications terminal, to the host when the communications terminal uses the roaming server as the current default server of the communications terminal.

To achieve the objective of the present invention, there is provided a communications system, which includes a host and the above server. The host includes a means for storing an internet protocol packet destination of the communications terminal, a means for updating the internet protocol packet destination of the communications terminal based on the transfer destination information of the communications terminal, a means for transmitting the internet protocol packet of the communications terminal, a means for receiving the transfer destination information of the communications terminal, and a means for transmitting data addressed to the communications terminal. The means for transmitting the internet protocol packet transmits the internet protocol packet of the communications terminal, which is addressed to the communications terminal, based on the internet protocol packet destination of the communications terminal, which is stored in the means for storing the internet protocol packet destination of the communications terminal. The means for transmitting the data transmits the data to the communications terminal only through the roaming server when the roaming server is indicated as the current default server of the communications terminal by the internet protocol packet destination of the communications terminal stored in the means for storing the internet protocol packet destination.

To achieve the objective of the present invention, there is also provided an internet protocol packet transferring method. In the method, an internet protocol packet is received at a first server. The internet protocol packet is transmitted from a host and is addressed to a communications terminal, which uses the first server as a home server. A correspondence table stored in the first server is searched based on the internet protocol packet to obtain transfer destination information, which indicates a current default server of the communications terminal, when the communications terminal uses a second server, which serves as a roaming server of the communications terminal, as the current default server of the communications terminal such that the transfer destination information indicates the second server as the current default server of the communications terminal. The correspondence table indicates a relationship between a communications terminal identification number of the communications terminal and the current default server of the communications terminal. The transfer destination information is transmitted from the first server to the host. An internet protocol packet destination of the communications terminal stored in the host is changed to make the second server as the internet protocol packet destination of the communications terminal, to allow transmission of any further internet protocol packet, which is addressed to the communications terminal, directly from the host to the second server.

### BRIEF DESCRIPTION OF THE DRAWINGS

The invention, together with additional objectives, features and advantages thereof, will be best understood from the following description, the appended claims and the accompanying drawings in which:

FIG. 1 is a schematic view of a cellular phone system according to an embodiment of the present invention;

FIG. 2 is a sequence diagram showing operation of the cellular phone system;

FIG. 3 is a sequence diagram similar to FIG. 2 showing part of the operation of the cellular phone system;

FIG. 4 is a schematic view of a previously proposed cellular phone system, showing part of operation of the previously proposed cellular phone system;

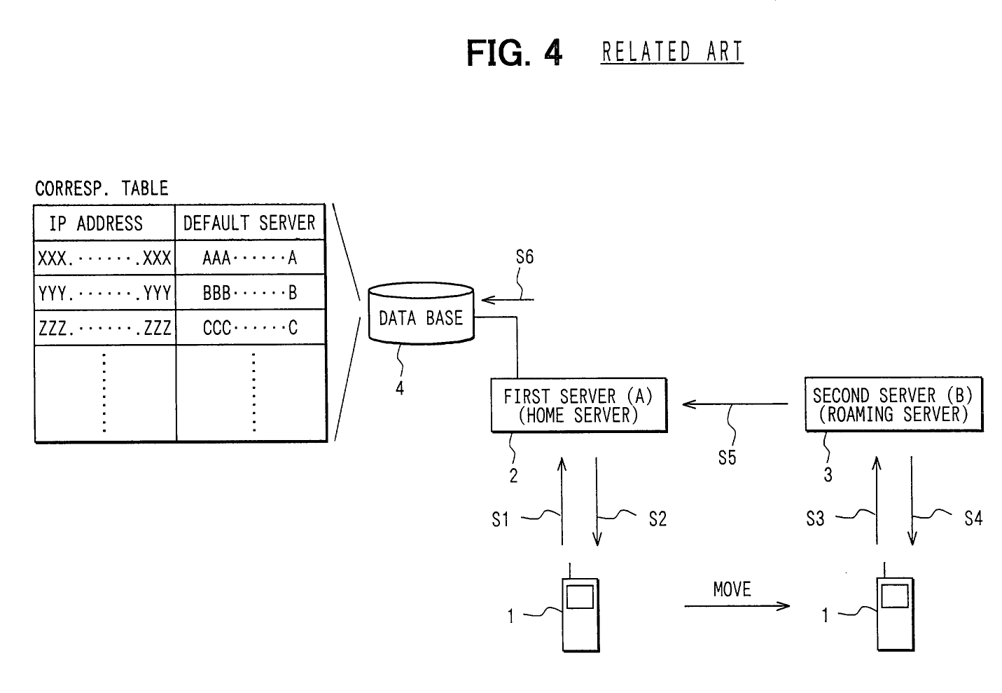

FIG. 5 is a schematic view similar to FIG. 4, showing another part of operation of the previously proposed cellular phone system; and

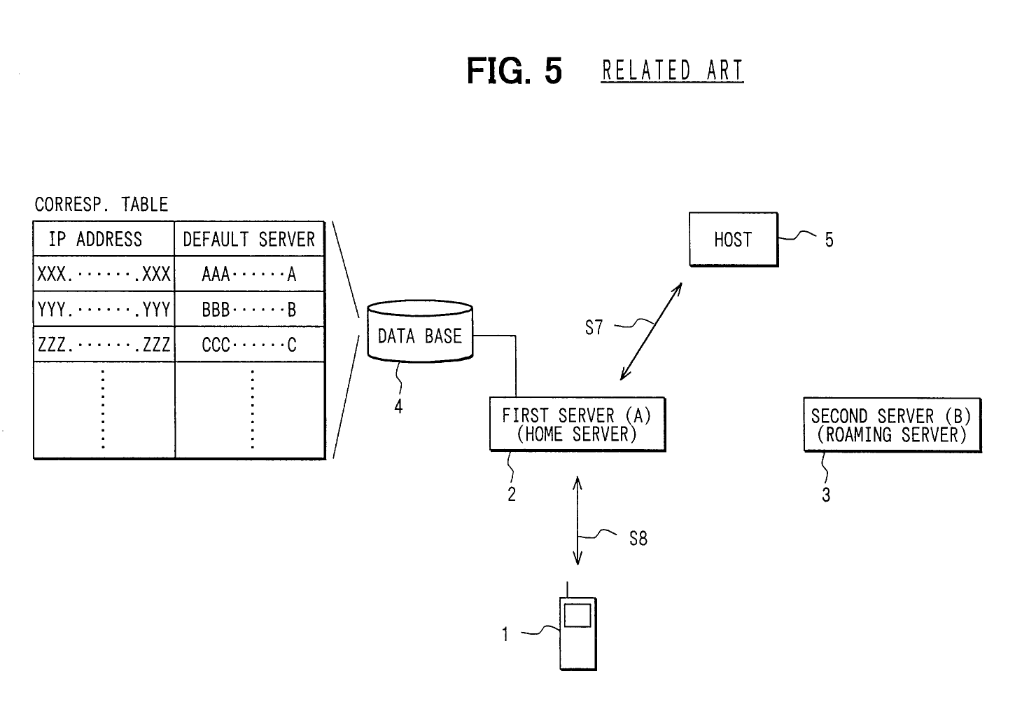

FIG. 6 is a schematic view similar to FIGS. 4 and 5, showing another part of the operation of the previously proposed cellular phone system.

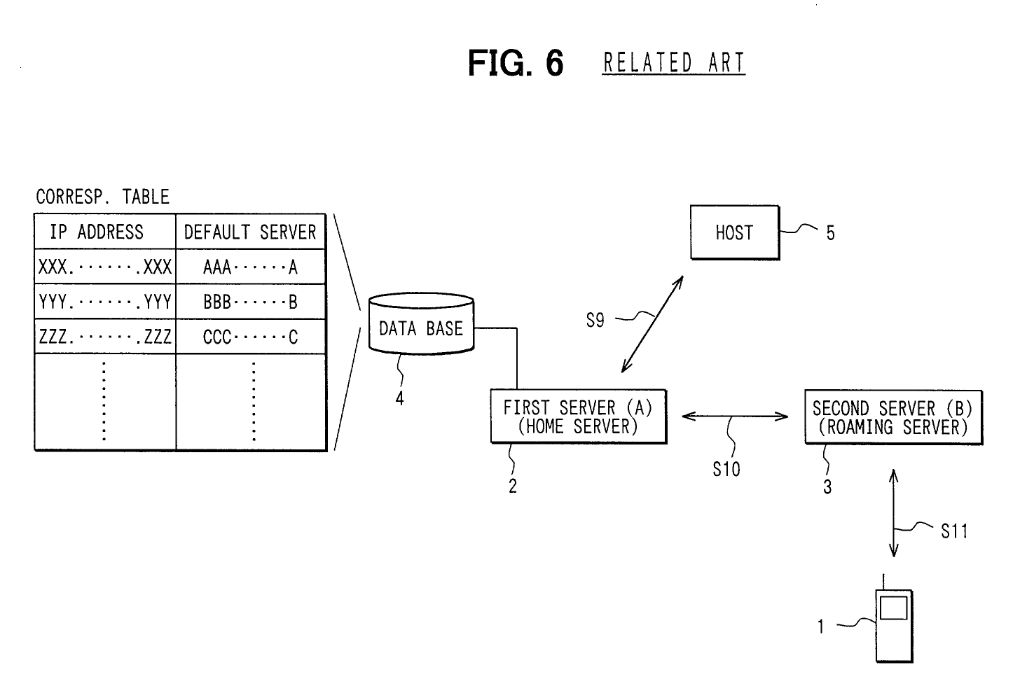

### DETAILED DESCRIPTION OF THE INVENTION

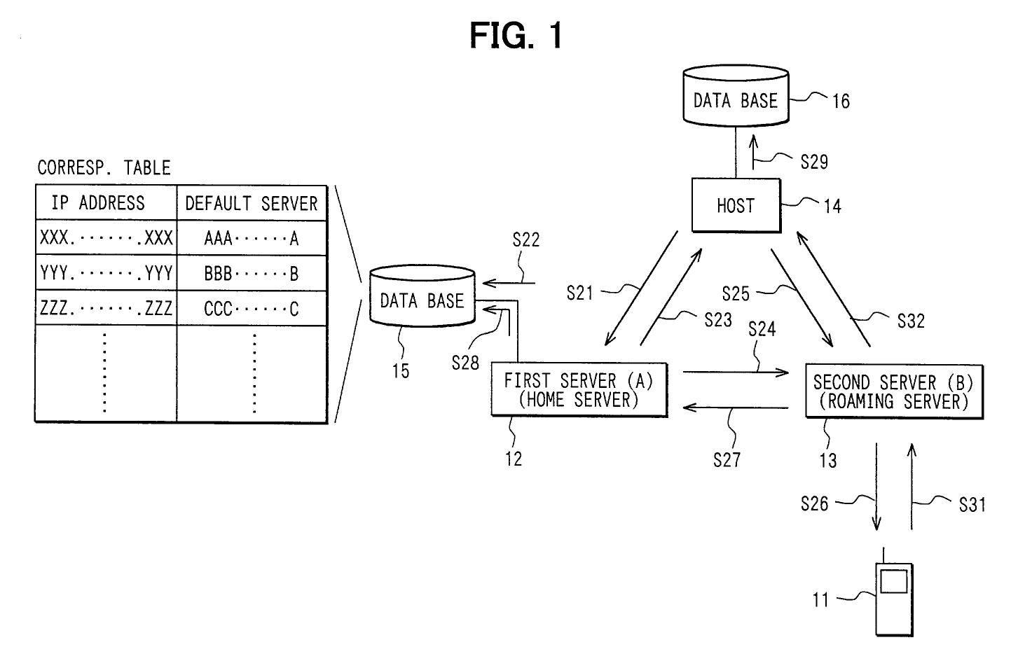

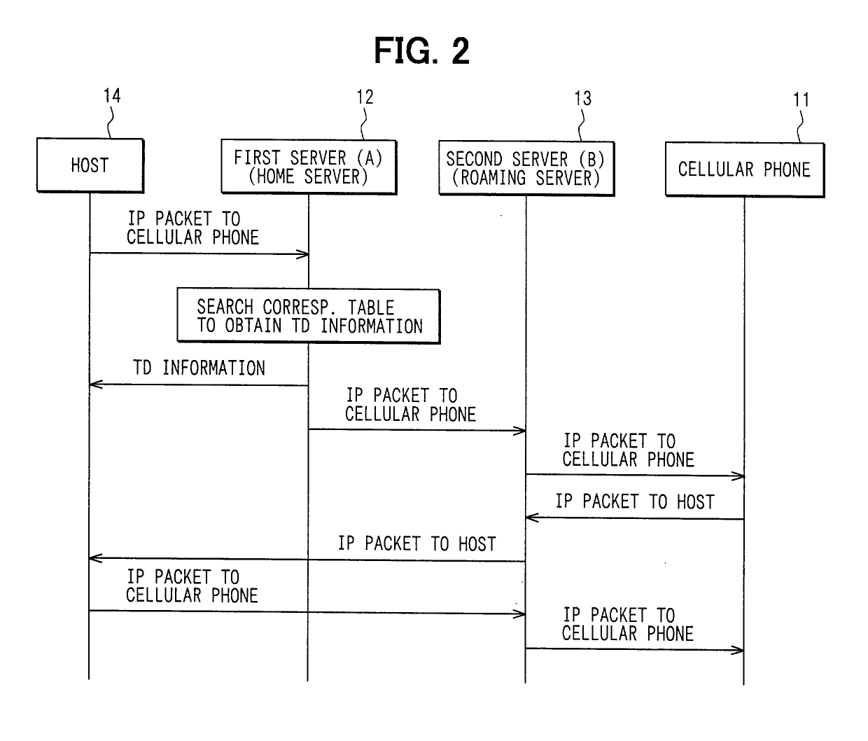

A cellular phone system according to an embodiment of the present invention will be described with reference to FIGS. 1-3.

FIG. 1 schematically shows an entire structure of the cellular phone system. With reference to FIG. 1, the cellular phone system uses the internet protocol as a communication protocol. IP packets are transmitted among a cellular phone 11, a first server 12, a second server 13 and a host 14. The first server 12 serves as a home server, which stores various information (e.g., a telephone number, an IP address, etc.) of the cellular phone 11. The first server 12 has a database (serving as a means for storing a correspondence table) 15, which stores a correspondence table. The correspondence table indicates a relationship between the IP address (serving as a communications terminal identification number) of the cellular phone 11 and a current default server (i.e., server currently used by the cellular phone) of the cellular phone 11.

The second server 13 serves as a roaming server of the cellular phone 11. When the cellular phone 11 is located within a communication range of the second server 13, the second server 13 transmits corresponding transfer destination information of the cellular phone 11 to the first server 12 at S27 in FIG. 1. In this case, the transfer destination information indicates that the cellular phone 11, which does not use the second server 13 as a home server of the cellular phone 11, is located within the communication range of the second server 13. When the first server 12 receives the transfer destination information from the second server 13 at S27 (serving as a means for receiving the transfer destination information of the communications terminal) in FIG. 1, the first server 12 interprets the transfer destination information and recognizes that the cellular phone 11 uses the second server 13 as the default server of the cellular phone 11. Then, the first server 12 updates the correspondence table stored in the database 15 based on this information at S28 (serving as a means for updating the correspondence table) in FIG. 1.

Operation of the above arrangement will be described with reference to FIGS. 1-3.

When the host 14 receives a request for transmitting an IP packet, which is addressed to the cellular phone 11, the host 14 transmits the IP packet to the first server 12 at S21 (serving as a means for transmitting the internet protocol packet of the communications terminal provided in the host 14 and also serving as a means for receiving the internet protocol packet provided in the first server) in FIG. 1. At this stage, the IP packet is prepared by the host 14 based on a corresponding IP packet destination stored in a database (serving as a means for storing the internet protocol packet destination of the communications terminal) 16 of the host 14. When the first server 12 receives the IP packet, which is addressed to the cellular phone 11, from the host 14, the first server 12 recognizes that the destination of the received IP packet is the cellular phone 11. Then, the first server 12 searches the correspondence table stored in the database 15 at S22 (serving as a means for searching the correspondence table) in FIG. 1 and obtains corresponding transfer destination information, which indicates the current default server of the cellular phone 11.

As shown in FIG. 1, when the cellular phone 11 uses the second server 13 as the current default server, the first server 12 obtains the corresponding transfer destination information, which indicates that the cellular phone 11 uses the second server 13 as the current default server. Then, the first server 12 transmits the transfer destination information to the host 14 at S23 (serving as a means for transmitting the transfer destination information of the communications terminal in the first server and also serving as a means for receiving the transfer destination information of the communications terminal in the host) in FIG. 1. Then, the host 14 updates the IP packet destination of the cellular phone 11 stored in the database 16 based on the transmitted transfer destination information at S29 (serving as a means for updating the internet protocol packet destination of the communications terminal) in FIG. 1. Furthermore, the first server 12 transmits the IP packet received from the host 14 to the second server 13 at S24 in FIG. 1. Then, when the second server 13 receives the IP packet, which is addressed to the cellular phone 11, from the first server 12, the second server 13 transmits the received IP packet to the cellular phone 11 at S26 in FIG. 1.

On the other hand, when the host 14 receives the transfer destination information from the first server 12, the host 14 interprets the transfer destination information and recognizes that the cellular phone 11 uses the second server 13 as the current default server of the cellular phone 11 instead of using the first server 12. Then, the host 14 changes the destination of the IP packet, which is addressed to the cellular phone 11, to the second server 13 by updating the IP packet destination of the cellular phone 11 stored in the database 16. After this time point, the host 14 transmits each IP packet, which is addressed to the cellular phone 11, to the second server 13 without using the first server 12 at S25 in FIG. 1. When the second server 13 receives the IP packet, which is addressed to the cellular phone 11, from the host 14, the second server 13 transmits the received IP packet to the cellular phone at S26 in FIG. 1. In this way, the IP packet, which is addressed to the cellular phone 11, is transmitted from the host 14 to the cellular phone 11 only through the second server 13. Furthermore, it should be noted that data, which is addressed to the cellular phone 11, is also transmitted from the host 14 to the cellular phone 11 only through the second server 13 at S25 (serving as a means for transmitting data addressed to the communications terminal) and S26 in FIG. 1.

At this stage, the cellular phone 11 has already received the IP packet, which is addressed to the cellular phone 11, from the host 14 without using the first server 12, so that when the second server 13 receives an IP packet, which is addressed to the host 14, from the cellular phone 11 at S31 in FIG. 1, the second server 13 transmits the IP packet, which is addressed to the host 14, to the host 14 without using the first server 12 at S32 in FIG. 1. Thus, the IP packet, which is addressed to the host 14, is transmitted from the cellular phone 11 to the host 14 only through the second server 13.

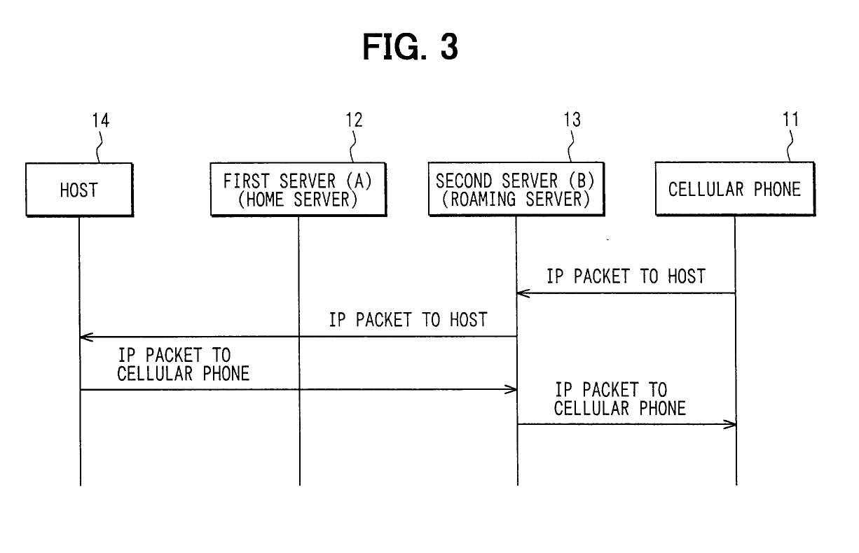

The embodiment has been described in connection with the case where the host 14 first transmits the IP packet, which is addressed to the cellular phone 11. Next, the embodiment will be described in connection with a case where the cellular phone 11 first transmits the IP packet, which is addressed to the host 14, with reference to FIGS. 1 and 3.

In this case, when the cellular phone 11 receives a request for transmitting the IP packet, which is addressed to the host 14, the cellular phone 11 transmits the IP packet, which is addressed to the host 14, to the second server 13 at S31 in FIG. 1. When the second server 13 receives the IP packet, which is addressed to the host 14, from the cellular phone 11, the second server 13 transmits the received IP packet to the host 14 without using the first server 12 at S32 in FIG. 1. In this way, the IP packet, which is addressed to the host 14, is transmitted from the cellular phone 11 to the host 14 only through the second server 13.

When the host 14 receives the IP packet, which is addressed to the host 14, from the second server 13, the host 14 recognizes that the IP packet is transmitted from the second server 13. Thereafter, the host 14 changes the transfer destination of the cellular phone 11 to the second server 13, and the host 14 transmits the IP packet, which is addressed to the cellular phone 11, to the second server 13 without using the first server 12. When the second server 13 receives the IP packet, which is addressed to the cellular phone 11, from the host 14, the second server transmits the received IP packet to the cellular phone 11. In this way, the IP packet, which is addressed to the cellular phone 11, is transmitted from the host 14 to the cellular phone 11 only through the second server 13.

As described above, according to the present embodiment, when the first server 12 receives the IP packet, which is addressed to the cellular phone 11, and the cellular phone 11 uses the roaming server 13 as the current default server, the first server 12 searches the correspondence table, which indicates the relationship between the IP address of the cellular phone 11 and the current default server of the cellular phone 11. Then, the first server 12 obtains the corresponding transfer destination information, which indicates the roaming server 13 as the current default server of the cellular phone 11, and transmits the transfer destination information to the host 14.

Thus, even in the case where the cellular phone 11 uses the roaming server as the current default server of the cellular phone 11, when the host 14 receives the transfer destination information from the first server 12, the host 14 can recognize that the roaming server of the cellular phone 11, to which the IP packet is addressed, is the second server 13. Thereafter, when the host 14 changes the destination of the IP packet, which is addressed to the cellular phone 11, to the second server 13, the second server 13 can directly receives the IP packet, which is addressed to the cellular phone 11, from the host 14. Furthermore, when the second server 13 receives the IP packet, which is addressed to the host 14, from the cellular phone 11, the second server 13 can directly transmit the received IP packet, which is addressed to the host 14, to the host 14. In this way, the IP packet can be transmitted between the host 14 and the cellular phone 11 only through the second server 13 without using the first server 12. This allows a reduction in the load of the corresponding network.

The present invention is not limited to the above embodiment. The above embodiment can be modified as follows.

The communications terminal is not limited to the cellular phone, and a personal digital assistant (PDA) can be used as the communications terminal in place of the cellular phone.

Additional advantages and modifications will readily occur to those skilled in the art. The invention in its broader terms is therefore, not limited to the specific details, representative apparatus, and illustrative examples shown and described.

What is claimed is:

1. A server comprising:
a means for receiving an internet protocol packet, wherein the means for receiving the internet protocol packet receives an internet protocol packet, which is transmitted from a host and is addressed to a communications terminal that uses the server as a home server of the communications terminal;
a means for storing a correspondence table, which indicates a relationship between a communications terminal identification number of the communications terminal and a current default server of the communications terminal;
a means for searching the correspondence table, wherein the means for searching the correspondence table searches the correspondence table to obtain transfer destination information of the communications terminal, which indicates the current default server of the communications terminal, when the communications terminal uses a roaming server as the current default server of the communications terminal such that the transfer destination information of the communications terminal indicates the roaming server as the current default server of the communications terminal; and
a means for transmitting the transfer destination information of the communications terminal, wherein the means for transmitting the transfer destination information transmits the transfer destination information of the communications terminal, which indicates the roaming server as the current default server of the communications terminal, to the host when the communications terminal uses the roaming server as the current default server of the communications terminal.

2. A server according to claim 1, further comprising a means for receiving the transfer destination information of the communications terminal, wherein:
the means for receiving the transfer destination information of the communications terminal receives the transfer destination information of the communications terminal from the roaming server when the communications terminal is located within a communication range of the roaming server; and
the transfer destination information of the communications terminal, which is transmitted from the roaming server, indicates the roaming server as the current default server of the communications terminal.

3. A server according to claim 2, further comprising a means for updating the correspondence table, which is stored in the means for storing the correspondence table, wherein the means for updating the correspondence table updates the correspondence table by interpreting the transfer destination information of the communications terminal, which is received from the roaming server, when the means for receiving the transfer destination information receives the transfer destination information from the roaming server.

4. A server according to claim 1, wherein the transfer destination information, which is transmitted from the means for transmitting the transfer destination information to the host and indicates the roaming server as the current default server of the communications terminal, is constructed to cause an internet protocol packet destination of the communications terminal stored in the host to be changed to make the roaming server as the internet protocol packet destination of the communications terminal, so that corresponding data addressed to the communications terminal is directly transmitted from the host to the roaming server.

5. A communications system comprising:
a host, which includes:
a means for storing an internet protocol packet destination of a communications terminal;
a means for updating the internet protocol packet destination of the communications terminal, which is stored in the means for storing the internet protocol packet destination of the communications terminal, based on transfer destination information of the communications terminal, which indicates a current default server of the communications terminal;
a means for transmitting an internet protocol packet of the communications terminal, wherein the means for transmitting the internet protocol packet transmits the internet protocol packet of the communications terminal, which is addressed to the communications terminal, based on the internet protocol packet destination of the communications terminal, which is stored in the means for storing the internet protocol packet destination of the communications terminal;
a means for receiving the transfer destination information of the communications terminal; and
a means for transmitting data addressed to the communications terminal; and
a server, which includes:
a means for receiving an internet protocol packet, wherein the means for receiving the internet protocol packet receives the internet protocol packet, which is transmitted from the host and is addressed to the communications terminal that uses the server as a home server of the communications terminal;
a means for storing a correspondence table, which indicates a relationship between a communications terminal identification number of the communications terminal and the current default server of the communications terminal;
a means for searching the correspondence table, wherein the means for searching the correspondence table searches the correspondence table to obtain transfer destination information of the communications terminal, which indicates the current default server of the communications terminal, when the communications terminal uses a roaming server as the current default server of the communications terminal such that the transfer destination information of the communications terminal indicates the roaming server as the current default server of the communications terminal; and
a means for transmitting the transfer destination information of the communications terminal, wherein the means for transmitting the transfer destination information transmits the transfer destination information of the communications terminal, which indicates the roaming server as the current default server of the communications terminal, to the host when the communications terminal uses the roaming server as the current default server of the communications terminal, wherein the means for transmitting the data provided in the host transmits the data to the communications terminal only through the roaming server when the roaming server is indicated as the current default server of the communications terminal by the internet protocol packet destination of the communications terminal stored in the means for storing the internet protocol packet destination provided in the host.

6. An internet protocol packet transferring method comprising:
receiving an internet protocol packet at a first server, wherein the internet protocol packet is transmitted from a host and is addressed to a communications terminal, which uses the first server as a home server;
searching a correspondence table stored in the first server based on the internet protocol packet to obtain transfer destination information, which indicates a current default server of the communications terminal, when the communications terminal uses a second server, which serves as a roaming server of the communications terminal, as the current default server of the communications terminal such that the transfer destination information indicates the second server as the current default server of the communications terminal, wherein the correspondence table indicates a relationship between a communications terminal identification number of the communications terminal and the current default server of the communications terminal;
transmitting the transfer destination information from the first server to the host; and
changing an internet protocol packet destination of the communications terminal stored in the host to make the second server as the internet protocol packet destination of the communications terminal, to allow transmission of any further internet protocol packet, which is addressed to the communications terminal, directly from the host to the second server.

7. An internet protocol packet transferring method according to claim 6, further comprising transmitting data, which is addressed to the communications terminal, directly from the host to the second server when the transfer destination information received from the first server indicates the second server as the current default server of the communications terminal.
